(19) United States
(12) Patent Application Publication
(10) Pub. No.: US 2003/0138167 A1
(43) Pub. Date: Jul. 24, 2003

(54) Method and a system for stitching images produced by two or more sensors in a graphical scanner

(76) Inventor: Joergen Rasmusen, Hoersholm (DK)

Correspondence Address: HARNESS, DICKEY & PIERCE, P.L.C., P.O. BOX 8910, RESTON, VA, 20195, US

(21) Appl. No.: 10/054,752

(22) Filed: Jan. 22, 2002

(51) Int. Cl. G06K 9/00; G06K 9/36; H04N 1/46

(52) U.S. Cl. 382/284; 382/162

(57) ABSTRACT

The present invention relates to a method and a system for seamlessly stitching images produced by two or more overlapping image sensors in a graphical scanner so that no hard changes in color occur due to differences in the sensors. The present invention introduces two ways of performing the stitching for each scanline. In a first aspect, the stitching is done by, for each pixel in the overlap, calculating a weighted sum of the corresponding pixel values while gradually shifting the weight from one sensor to the other. In another aspect, the stitching is done by choosing a pixel in the overlap according to a predefined, a random or a pseudo random pattern.

### FIELD OF THE INVENTION

The present invention relates to the field of color scanners containing multiple overlapping line sensors and the problem of creating a continues line image by stitching the images produced by the sensors together.

### BACKGROUND OF THE INVENTION

Traditionally multi sensor scanners have solved the problem of stitching up the images produced by neighboring sensors by slightly overlapping the sensors so that the scanner can stop reading pixels from one sensor and start reading pixels from the next sensor somewhere within this overlap. The stop and start pixels can be set by detection of a thin metal wire by the sensors, input manually or calculated automatically as patented by Contex.

This way of stitching works very well for black and white scanners where the output from the sensors is run through a threshold detector to determine for each pixel if the original is black or white. However, when doing color scanning much more information is recorded about each pixel. Typical color sensors consist of 3 rows of sensors detecting the level of red, green and blue, respectively. These RGB-levels are digitalized using analogue-to-digital converters (ADC).

The human eye is very sensitive to sharp changes in color, so to produce a seamless stitching it is required that two neighboring sensors produce almost identical RGB-output for a given pixel in the overlapping zone. This requirement is very hard to meet since it is technically extremely difficult and therefore very expensive to produce sensors that are virtually identical. Actually, no existing systems provide means for scanning a color image without creating visible transitions between image areas scanned with different sensors.

On the other hand, the human eye is quite insensitive to soft changes in color. The invention described in the following utilizes this fact.

### DESCRIPTION OF THE INVENTION

It is an object of the present invention to provide a method and a system which solves the above mentioned problem.

Thus, in a first aspect the present invention relates to a method for stitching at least a first line shaped image and at least a second line shaped image, said first image having an image part intersecting an image part of said second image, said first image being represented by at least a first array of adjacent pixel values, said second image being represented by at least a second array of adjacent pixel values, the method comprising the steps of:

locating the part of the first array that is included in the intersection of said images,

locating the part of the second array that is included in the intersection of said images,

defining, in at least a third array, a representation of the stitched image by

assigning the pixel values of the part of the first array outside the intersection to a first part of said third array,

assigning pixel values to represent the intersection of the at least two images to a second part of said third array, said pixel values being calculated by applying at least a first function to the corresponding pixel values of the intersecting parts of said first and second arrays,

assigning the pixel values of the part of the second array outside the intersection to a third part of said third array.

The first line shaped image and/or the second line shaped image may be provided by capturing a line image, i.e. an image extending substantially only in one direction. Such images may be captured by any photosensitive device. However, a CCD (Charge Coupled Device), CIS (Contact Image Sensor), CMOS (Complementary Metal-Oxide-Silicon) or similar light sensitive device that consist of arrays of light sensitive elements is preferred.

A CCD/CIS/CMOS device typically provides a response to a light intensity in the form of a collection of analogue signals, each analogue signal representing a single pixel. However, these analogue signals may preferably be converted into digital pixel values, e.g. by use of an analogue-to-digital converter (ADC).

Thus, the images will preferably be stored in a computer storage medium as an array of pixel values, each cell of the array corresponding to a single pixel.

Typically, each array will contain around 1,500-15,000 pixel values corresponding to a resolution of 50DPI-2400DPI.

Due to the intersection of the first and second images, the array of pixel values representing the first image and the array of pixel values representing the second image ill represent a common number of pixels. The length of this overlap should preferably be at least around 1 mm, corresponding to the number of pixels in the overlap preferably being around 32-1000, depending on the resolution. The number of pixels in the overlap has to be predetermined prior to the use of this method, i.e. the sub-arrays representing the overlapping part of the images can easily be derived from the original arrays.

Now, the arrays representing the first and second images, respectively, can be stitched together in a third array. This is done by copying the pixel values outside the overlap directly to the third array while new pixel values representing the overlap are calculated for each pixel in the overlap by applying a function to the pixel values of the first and second arrays, said function also being dependent on the position in the overlap, i.e. the actual pixel.

Frequently, the captured line shaped images will contain more than one color component and in this case, the images will be stored in the computer storage medium as a two-dimensional array (i.e. an array containing more than one value for each pixel). An example is an array containing for each pixel the intensity of red light, the intensity of green light and the intensity of blue light, so that a standard RGB-representation is obtained.

According to a preferred embodiment of the present invention, the function used for calculating the pixel values of the overlap will calculate a weighted sum of the corresponding pixel values of the first and second images, i.e. the function will have the form

f(x₁, x₂)=w₁*x₁+w₂*x₂

In this formula x₁ denotes a pixel value of the overlap taken from the first array, x₂ denotes the corresponding pixel value taken from the second array and w₁ and w₂ denotes the weights applied to the pixel values. Both w₁ and w₂ are functions themselves as they are defined individually for each pixel in the overlap.

In the above-mentioned case where the arrays are two-dimensional, a unique function will be used for calculating the weighted sums for each color component. In the RGB-case this means that a first function, f_{R}, will be applied to the R-components, a second function, f_{G}, will be applied to the G-components and a third function, f_{B}, will be applied to the B-components of the arrays.

In order to keep the overall level of the pixel values, which is to be preferred since they represent a certain level or intensity, the sum of the weights w₁ and w₂ equals 1 for each pixel in the overlap, i.e. w₁+w₂=1.

As mentioned above, the exact values of the weights used for calculating the pixel values in the overlap of the first and second images are preferably defined individually for each single pixel in the overlap. One way of defining these values is to split the overlap of the first and second images in three by selecting a first and a second pixel within the overlap. For all pixels in the part of the overlap bound by the first and second selected pixels, both included, the weight coefficient applied to the pixel values of the first array are given by an overall decreasing function when stepping through the pixel values, step by step from the first to the second selected pixels. For the pixels contained in the part of the overlap bound by the first selected pixel and one end of the overlap the weight applied to the pixel values of the first array are all set to 1 (one), and in the remaining part of the overlap the weight is set to 0 (zero). The value of the weight coefficient applied to the pixel values of the second array are given by the condition w₁+w₂=1.

The overall decreasing function defining the weight coefficients applied to the pixel values of the first array bound by the first and second selected pixels, both included, could as well be replaced by an overall increasing function. In this case, the weight applied to the pixel values of the first array are all set to 0 (zero) for the pixels bound by the first selected pixel and one end of the overlap, and in the remaining part of the overlap the weight is set to 1 (one).

The overall decreasing/increasing function defining the weights applied to the pixel values of the first array in the part of the overlap which is bound by the first and second selected pixels, can preferably be selected among the following:

a linear function,

a polynomial, e.g.

a polynomial of at least second order,

a polynomial of at least third order,

a polynomial of at least third order,

a polynomial of at least fourth order,

a polynomial of at least fifth order,

a polynomial containing only even powers,

a polynomial containing only odd powers,

a function given by a table, i.e. a table containing the function value corresponding to each of the pixels it is to be applied to.

The situation where the function is given by a table will be the simplest and fastest, and thus the most preferable choice. This is mainly due to the fact that no computation of function values has to be performed during operation since the function values are precalculated and stored in a table.

Calibration of the system is done as described in U.S. Pat. No. 5,117,295 which is hereby included in this text by reference.

In another preferred embodiment of the present invention the first and second selected pixels of the overlap are identical, i.e. only one pixel is selected. This single pixel can preferably be selected

according to a predefined pattern,

according to a random pattern, or

according to a pseudo random pattern.

The stitching is then performed for each scanline by assigning the pixel values produced by the first camera to the stiched picture until reaching the selected pixel (according to the chosen pattern) and from then on assigning the pixel values produced by the second camera to the stiched picture.

### BRIEF DESCRIPTION OF THE DRAWINGS

FIG. 1 shows parts of two arrays of pixel values produced by two overlapping sensors.

FIG. 2 shows RGB output from a color sensor stored in an array.

FIG. 3 shows a system for mixing the output of two cameras using multipliers and adders.

FIG. 4 shows a scanner block diagram.

FIG. 5 shows an example of an uncorrected output from the ADC of FIG. 4.

FIG. 6 shows an example of a corrected output from the multiplier of FIG. 4.

FIG. 7 shows how to stitch the output from 2 cameras using ramps and adder.

FIG. 8 shows a situation where the stitching point is varied according to a pattern.

FIG. 9 shows how a sample RAM can be used to set resolution and to stitch.

### DETAILED DESCRIPTION OF THE DRAWINGS

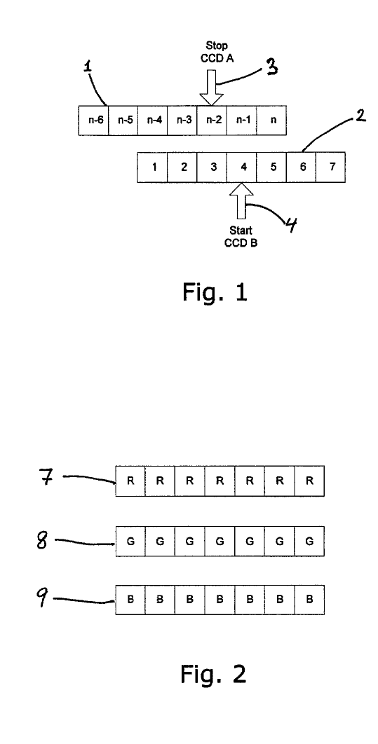

FIG. 1 shows a part of a first array (1) and a part of a second array (2), the two arrays containing pixel values produced by two overlapping sensors (referred to as CCD A and CCD B), i.e. the arrays contain digital representations of a first and a second line shaped image. In the example of FIG. 1, the two arrays have 5 pixels in common: pixel no. n-4 of the first array (1) corresponds to pixel no. 1 of the second array (2), pixel no. n-3 of the first array (1) corresponds to pixel no. 2 of the second array (2) and vice versa. Furthermore, FIG. 1 comprises a first pointer (3) addressed to pixel no. n-2 of the first array (1) and a second pointer (4) addressed to pixel no. 4 of the second array (2). These first and second pointers (3 and 4) indicates the last pixel of the first array (1) and the first pixel of the second array (2), respectively, to be included when stitching the first and second images.

FIG. 2 shows a two-dimensional array for storing digital RGB output from a color sensor. The array contains three rows (7, 8 and 9) for storing corresponding R, G and B values, respectively.

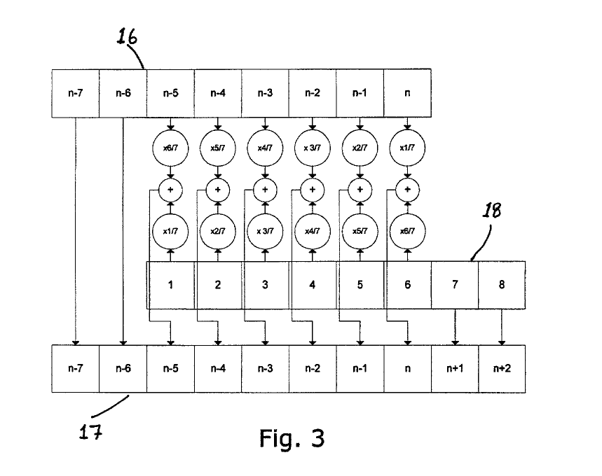

FIG. 3 shows a system for mixing the output of two overlapping cameras/sensors, which is stored in a first (16) and a second (17) array. The mixing is performed by calculating a mixed sum of the corresponding pixel values from the first (16) and second (17) array. This calculation is performed by, for each pixel contained in the overlap of the sensors, multiplying the pixel value stored in the first array (16) by a first weight coefficient, multiplying the pixel value stored in the second array (17) by a second weight coefficient and finally, adding the two weighted pixel values to arrive at a resulting pixel value, which is stored in a third array (18). The sum of the first and second weight coefficients preferably equals 1 (one) for each pixel.

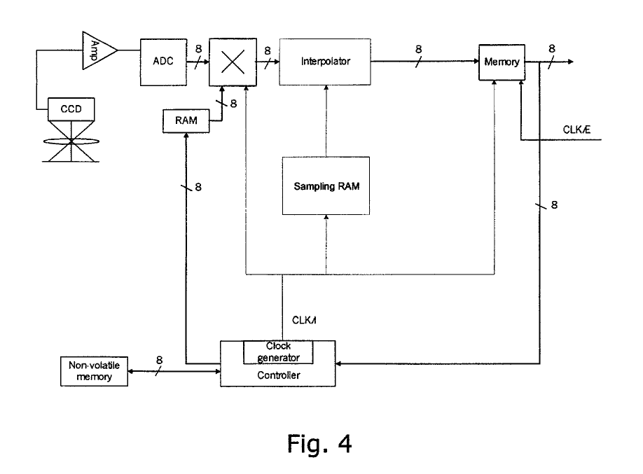

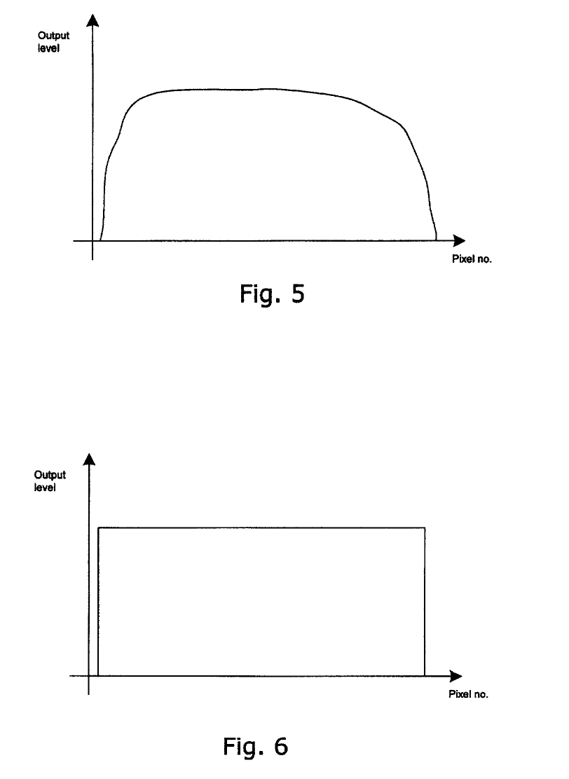

FIG. 4 shows a block diagram of a typical scanner in which the system for stitching could be implemented. In FIG. 5 it is shown how the output level of the ADC, when the sensor (CCD) of the scanner is seeing a uniform white background, is not the same for all the recorded pixels. The preferred shape of the output of the ADC is shown in FIG. 6 and can be obtained in the scanner of FIG. 4 by multiplying the output of the ADC with correction factors stored in the RAM (memory). These correction factors can be found as described in the patent U.S. Pat. No. 5,117,295.

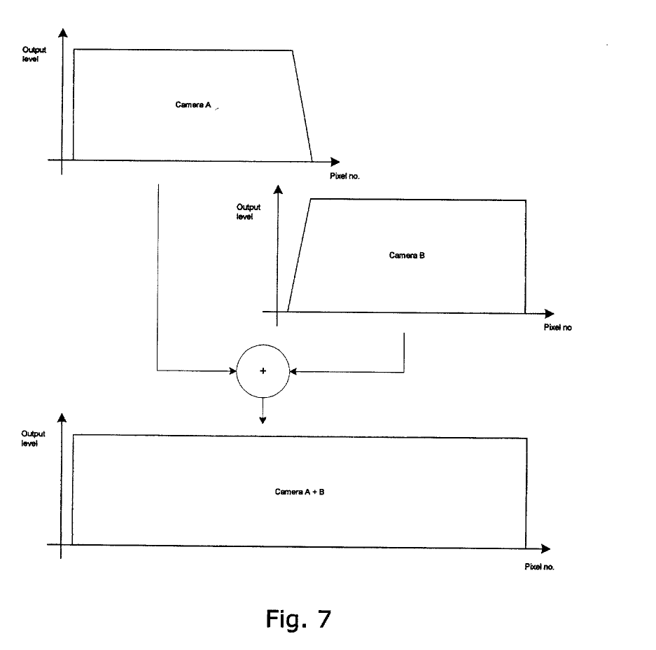

FIG. 7 shows how the output from 2 cameras/sensors can be stitched by adding a ramp at the end of camera A and at the beginning of camera B.

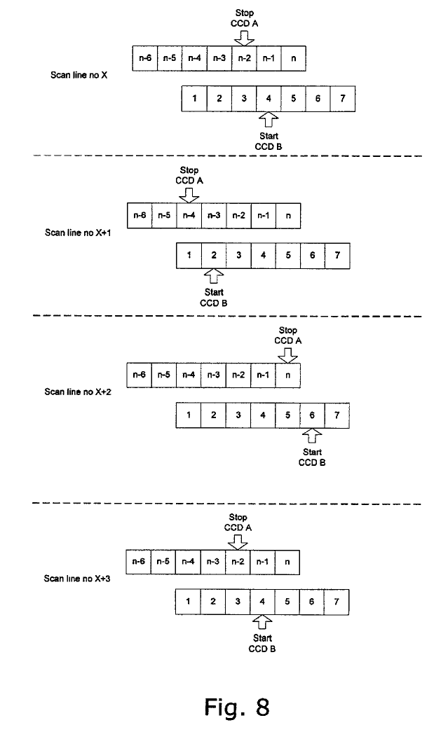

FIG. 8 shows a situation where the placement of the stitching point is varied for each individual scan line. The variation of the stitching point preferably follows a pseudo random pattern, but could equally well follow a truly random pattern or any predefined pattern.

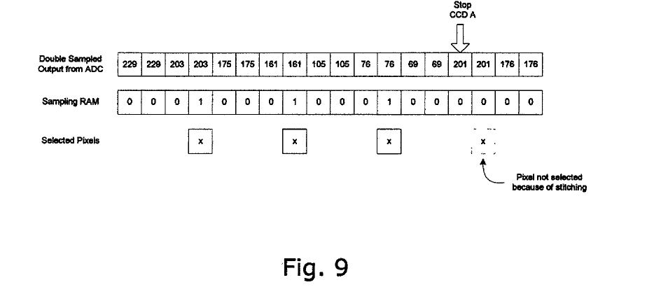

FIG. 9 shows how a sample RAM, e.g. the sample RAM shown in FIG. 4, can be used to set resolution and to stitch. The output from the ADC is sampled with twice the rate of the CCD used. The sample RAM is loaded with a pattern of zeros and ones, with a one or a zero for each double sampled pixel. If the sampling RAM is loaded with a one, the interpolator uses the corresponding double sampled pixel as valid, if it is a zero then the pixel is not used. This way any resolution up to the double of the CCD resolution can be produced. Furthermore, the sampling RAM can be used to perform the stitching: After the stitching point of the first sensor, the controller loads the sampling RAM with zeros so that no more pixels from the first camera are used after the stitching point. Analogously, the sampling RAM is loaded with zeros until the stitching point of the second sensor so that no pixels produced by the second camera are used before the stitching point. The sampling RAM may contain a number of different patterns for providing different stitchings. By (pseudo) randomly choosing between these different patterns before the start of each scan line, a sharp stitching from one camera to another may be avoided.

1. A method for stitching at least a first line shaped image and at least a second line shaped image, said first image having an image part intersecting an image part of said second image, said first image being represented by at least a first array of adjacent pixel values, said second image being represented by at least a second array of adjacent pixel values, the method comprising the steps of:
locating the part of the first array that is included in the intersection of said images,
locating the part of the second array that is included in the intersection of said images,
defining, in at least a third array, a representation of the stitched image by
assigning the pixel values of the part of the first array outside the intersection to a first part of said third array,
assigning pixel values to represent the intersection of the at least two images to a second part of said third array, said pixel values being calculated by applying at least a first function to the corresponding pixel values of the intersecting parts of said first and second arrays,
assigning the pixel values of the part of the second array outside the intersection to a third part of said third array.

2. A method according to claim 1, wherein said first function calculates a weighted sum.

3. A method according to claim 2, wherein the sum of the weights multiplied to the pixel values when calculating the weighted sum equals 1 for all pixels included in the intersection.

4. A method according to claim 3, wherein a first and a second pixel included in the intersection are selected, and the weights applied to the pixel values when stepping through the first array equals 1 before reaching said first selected pixel, then the weight is decreasing or unchanged pixel by pixel and when reaching the pixels after said second selected pixel, the weight equals 0.

5. A method according to claim 3, wherein a first and a second pixel included in the intersection are selected, and the weights applied to the pixel values when stepping through the first array equals 0 before reaching said first selected pixel, then the weight is increasing pixel by pixel and when reaching the pixels after said second selected pixel, the weight equals 1.

6. A method according to claim 4, wherein the decreasing/increasing is given by a linear function.

7. A method according to claim 4, wherein the decreasing/increasing is given by a polynomial.

8. A method according to claim 7, wherein the polynomial is at least of second order.

9. A method according to claim 7, wherein the polynomial is at least of third order.

10. A method according to claim 7, wherein the polynomial is at least of fourth order.

11. A method according to claim 7, wherein the polynomial is at least of fifth order.

12. A method according to claim 7, wherein the polynomial contains only even powers.

13. A method according to claim 7, wherein the polynomial contains only odd powers.

14. A method according to claim 4, wherein the weights are given by a table of predetermined values.

15. A method according to claim 4, wherein said selected pixels are identical.

16. A method according to claim 15, wherein said selected identical pixels are selected by following a predefined pattern.

17. A method according to claim 15, wherein said selected identical pixels are selected by following a random pattern.

18. A method according to claim 15, wherein said selected identical pixels are selected by following a pseudo random pattern.

19. A system for stitching at least a first and a second line shaped image produced by a plurality of light sensitive elements in a graphical scanner, said first image having an image part intersecting an image part of said second image, the system comprising:
a computer system with an operating system, the computer system comprising input means for entering at least data representations of said first and second images into the system, processing means for processing the data, output means for outputting a result and data storage means having stored therein at least a computer program, the processing means being adapted to respond to commands from the computer program by:
locating the part of the representation of said first image that is included in the intersection of said images,
locating the part of the representation of said second image that is included in the intersection of said images,
defining, in the storage medium of the system, a representation of the stitched image by
assigning the part of the data representation of said first image not contained in the intersection to a first part of the data representation of the stitched image,
assigning a calculated data representation of the intersection to a second part of the data representation of the stitched image, the calculated data representation being defined from the corresponding data representations of the images contained in the overlapping,
assigning the part of the data representation of said second image not contained in the intersection to a third part of the data representation of the stitched image,

20. A system according to claim 19, wherein the calculated data representation is a weighted sum.

21. A system according to claim 20, wherein the sum of the weights used for calculating the weighted sum equals 1.

22. A system according to claim 21, wherein a first and a second pixel included in the intersection are selected, and the weight applied to the pixel values when stepping through the representation of the first image equals 1 before reaching said first selected pixel, then the weight is decreasing pixel by pixel and when reaching the pixels after said second selected pixel, the weight equals 0.

23. A system according to claim 21, wherein a first and a second pixel included in the intersection are selected, and the weight applied to the pixel values when stepping through the representation of the first image equals 0 before reaching said first selected pixel, then the weight is increasing pixel by pixel and when reaching the pixels after said second selected pixel, the weight equals 1.

24. A system according to claim 22, wherein the decreasing/increasing is given by a linear function.

25. A system according to claim 22, wherein the decreasing/increasing is given by a polynomial.

26. A system according to claim 22, wherein the weights are given by a table of predetermined values, said table being stored in the storage means of the system.

27. A system according to claim 22, wherein said selected pixels are identical.

28. A system according to claim 27, wherein said selected identical pixels are selected according to a predefined pattern, said pattern being stored in the storage means of the system.

29. A system according to claim 27, wherein said selected identical pixels are selected according to a random pattern, said pattern being stored in the storage means of the system.

30. A system according to claim 27, wherein said selected identical pixels are selected according to a pseudo random pattern, said pattern being stored in the storage means of the system.
